(19) United States
(12) Patent Application Publication
(10) Pub. No.: US 2026/0120170 A1
(43) Pub. Date: Apr. 30, 2026

(54) Machine Learning-Based Ingredient Classification and Filtering System for Item Database

(71) Applicant: Maplebear Inc., San Francisco, CA (US)

(72) Inventor: Naval Shah, Toronto (CA)

(21) Appl. No.: 18/933,758

(22) Filed: Oct. 31, 2024

(51) Int. Cl. G06Q 30/0601; G06N 20/00

(52) U.S. Cl. CPC G06Q 30/0633; G06N 20/00

(57) ABSTRACT

An online system enables users to generate an order for items by receiving a collection of components, such as a recipe. The online system maps the components to specific items available at a source. To avoid nonsensical mappings of a specific item to a component, the online system trains a model to predict a probability of a specific item being suitable for inclusion in at least one collection of components. For example, the model generates a probability of a specific item being included in at least one recipe comprising a plurality of components. The model may be trained using users' inclusion of specific items previously selected for one or more groups of items based on collections of components by users of the online system.

### BACKGROUND

Various online systems offer items for acquisition by users. For example, an online system receives an order including one or more items from a user and provides the items included in the order to the user. A user of an online system selects one or more items for inclusion in an order via one or more interfaces generated and presented by the online system. Subsequently, the user receives the selected items from the online system. For example, the online system allocates the order including the items to a picker who obtains the items included in the order from a source and delivers the obtained items to a location included in the order.

To simplify user selection of items, an online system may receive a collection of components and an identifier of a source from a user. A component comprises an attribute or description applicable to one or more specific items available from a source. For example, a component is a generic item description associated with multiple specific items available from a source. A generic item description may be an item category or other information identifying one or more attributes common to one or more specific items. For example, a collection of components includes a component that is a generic item description of “milk,” with multiple specific items (e.g., different brands of milk) associated with the generic item description available from a source. The online system applies one or more trained models to a component and to attributes of specific items available from the source to select a specific item offered by the identified source for the component. This allows generation of a group of specific items available from the source corresponding to the components of the collection. For example, the group of specific items is an order including a specific item corresponding to each component of the collection.

Conventional models applied to collections of components by online systems often use a component as a search query and retrieve specific items based on measures of relevance between specific items and the component. However, certain items may have high measures of relevance to a component but be nonsensical for inclusion in a collection of components. A specific item is nonsensical for mapping to a component when the specific item is incompatible or is inconsistent with other components of the collection. For example, a collection of components is a recipe including multiple components corresponding to food items, and a conventional model applied to a component for a food item may retrieve one or more specific items for a component that are not food items. In an example, a conventional model identifies an item comprising a cleaning product with a description or a name partially matching a component in a collection including components comprising food items. As sources offer large numbers of items, evaluating each item available from a source for a component, including items that are nonsensical for a collection including the component, is computationally intensive. Limiting a number of items evaluated for a component based on historical interactions by users would reduce computational resources and data retrieved by online systems to map components to specific items.

### SUMMARY

In accordance with one or more aspects of the disclosure, an online system enables a user to select items from a source, which the online system subsequently retrieves from the source and delivers to a location specified by the user. In various embodiments, the online system receives an order (e.g., from a user), which may comprise a selection of a group of items and a source from which to obtain the items. The online system allocates the group of items to a picker, who obtains the items from the source and delivers the obtained items to a location specified by the user.

To simplify selection of a group of items by a user, such as creation of an order, the online system may receive a collection of components from a user, from a third party system, or from an application. Each component of a collection comprises one or more attributes or descriptive information applicable to one or more specific items available from a source. For example, the collection may be a recipe that specifies a set of ingredients, and the components of the collection are the ingredients in the recipe. In some embodiments, a component is a generic item description associated with one or more specific items available from a source, while in other embodiments a component identifies one or more attributes of one or more specific items available from a source. In the context of a recipe, an ingredient may be specified generically (e.g., “milk”), and the specific items are actual products that match the ingredient and thus can be used for the ingredient in the recipe (e.g., “Brand X 2% milk”). In one or more embodiments, a computing system receives a recipe that specifies a set of ingredients and then matches one or more of the ingredients to a set of corresponding products available from a source, as described in U.S. Patent No. 11,676,196, and U.S. Application No. 17/476,475, filed September 16, 2021, each of which is incorporated by reference in its entirety.

However, multiple specific items available from a source may satisfy a component. For example, a component of “bread” is satisfied by multiple specific items available from a source that each comprise different brands of bread, different types of bread, or milk items having one or more differing attributes. Because multiple specific items available from a source may be used for a component, to create a group of specific items capable of being obtained from the source, the online system maps a component to a specific item available from a source. Mapping each component of a collection to a corresponding specific item available from a source allows creation of a group of items capable of being obtained from a source for the collection of components.

To map a component to a specific item, the online system may generate a search query based on one or more attributes of the component (e.g., a name of the component, a description of the component) and select a specific item based on measures of relevance of attributes of various items available from a source to the search query. However, certain items available from a source may have high measures of relevance to a component in a collection but be nonsensical for use in the collection. A specific item is nonsensical for a collection if the specific item is inconsistent or incompatible with other components (or with specific items mapped to other components) of the collection. For example, a collection includes components corresponding to food items, while a specific item available from a source is a non-food item having attributes (e.g., a name, a description) causing a high measure of relevance to one of the components. In the preceding example, including such a specific non-food item in the collection of food components would be nonsensical, as the specific non-food item is incompatible with specific food items for the other components of the collection. When selecting a specific item for a component of a collection, evaluating items available from the source that would be nonsensical for the component also increases a number of items evaluated for the component, increasing computational resources expended by the online system for selecting a specific item for the component.

To reduce computational resources used for mapping a component to a specific item and to increase an accuracy of mapping of specific items to components, the online system identifies items available from a source. For example, the online system retrieves an item catalog for a source, with the item catalog identifying each item available from the source. The online system identifies an item available from the source and applies a machine-learning model to the item. The machine-learning model is trained based on collections of components and prior groups of items previously created by users of the online system. The online system generates training examples for the machine-learning model that each include attributes of a training item, with each training example having a label applied indicating whether the training item was included in at least one group of items based on at least one collection of components by one or more users. For example, a training example includes attributes of a training item and a label indicating whether a prior group of items based on at least one collection of components included the training item. The online system modifies one or more parameters of the machine-learning model through backpropagation during a training process.

Applying the machine learning model to attributes of the item generates a probability of the item being included in at least one group based on at least one collection of components by one or more users. The probability provides an indication whether the item is suitable for inclusion in a group of items based on a collection of components based on prior inclusion of items in one or more prior groups corresponding to one or more collections of components. The online system stores the probability in association with the item. In various embodiments, the probability is an attribute of the item stored in association with an identifier of the item. For example, the probability is included in an entry of the item catalog for the source associated with the item for subsequent retrieval by the online system.

Storing the probability in association with the item allows subsequent leverage of the probability of the item being included in one or more groups of items based on one or more collections of components when selecting items, or other content, for a user. In various embodiments, the online system receives a request to create a group of items including a specific collection of components. For a component of the specific collection, the online system selects a set of candidate items that each have at least a threshold probability of being included in one or more groups of items based on one or more collections of components. Filtering items available by the source based on their probabilities of being included in one or more groups of items based on one or more collections of components when selecting an item for a component reduces a number of items available from the source evaluated by the online system. Alternatively, the online system includes the probability of the item being included in one or more groups of items based on one or more collections of components as an attribute of the item provided as input to a selection model generating a score used by the online system to determine whether to select the item for association with a component.

Alternatively or additionally, the online system receives a group of items (e.g., an order) from a user and selects a collection of components based on the group of items. For example, the collection of components selected by the online system includes at least a threshold amount of the items in the received group. To select the collection of components, the online system identifies a set of items of the group that each have a stored probability of being included in one or more groups of items based on one or more collections of components. This removes items of the received group having less than the threshold probability of being included in one or more groups of items based on one or more collections of components from subsequent evaluation by the online system, reducing an amount of data processed by the online system. Based on the set of items, the online system selects one or more collections that each include at least a threshold amount of items of the set of items and identifies the selected one or more collections to the user. Selecting one or more collections based on specific items of the group having at least the threshold probability of being included in one or more groups of items based on one or more collections of components both reduces a number of specific items that the online system evaluates and increases an accuracy of the one or more collections selected by the online system for the received group of items by basing selection of one or more collections on specific items that are likely to be included in one or more groups based on at least one collection of components.

Additionally, when a specific item in a group received from a user is unavailable at a source, the online system may identify one or more candidate replacement items that are available at the source for the unavailable item. Identifying the one or more candidate replacement items allows the user to select an alternative item more easily for the group that is similar to the unavailable item. An item may be unavailable at the source in response to a picker obtaining a group of items transmitting an indication to the online system that the item is unavailable or in response to the online system determining a predicted availability of the item at the source is less than a threshold.

In various embodiments, to select candidate replacement items, the online system selects a set of candidate replacement items available from the source that each have at least a threshold probability of being included in at least one group based on at least one collection of components and selects one or more of the candidate replacement items for presentation to the user. Filtering items available from the source so the set of candidate replacement items each have at least the threshold probability of being included in at least one group based on at least one collection of components reduces a number of items available from the source evaluated for presentation to the user as a candidate replacement item. Alternatively or additionally, the online system uses the probability of being included in at least one group of items based on at least one collection of components for the item as an input to a replacement model that generates a replacement score for the item replacing the unavailable item, rather than filtering items available from the source based on their probabilities of being included in at least one group of items based on at least one collection of components. For example, the online system applies the replacement model to: characteristics of the user, attributes of the item unavailable from the source, and attributes of the item available from the source including the probability of the item being included in at least one group based on at least one collection of components. Based on the replacement scores for items available from the source, the online system selects one or more candidate replacement items for presentation to the user.

Determining probabilities of various items available from a source being included in at least one group of items based on at least one collection of components simplifies subsequent selection of one or more specific items available from the source by the online system. For example, the online system filters items available from the source by their probabilities of being included in at least one group of items based on at least one collection of components to reduce a number of items available from the source evaluated by the online system. This filtering reduces computational resources used by the online system by reducing a number of items the online system evaluates, which also reduces an amount of time spent by the online system selecting items for a component of a collection. Storing probabilities of various items available from a source being included in at least one group of items based on at least one collection of components also improves an accuracy with which the online system selects specific items selected by the online system for one or more components (or improves an accuracy of a collection of components selected based on a group of specific items), reducing an amount of interaction by users with the online system to generate a group of items, such as an order, based on a collection of components by reducing a likelihood of the users having to modify one or more items the online system selected for one or more components.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for determining probabilities of items available from a source being included in groups of items based on one or more collections of components, in accordance with one or more embodiments.

FIG. 4 illustrates a process flow diagram of a method for determining probabilities of items available from a source being included in groups of items based on one or more collections of components, in accordance with one or more embodiments.

### DETAILED DESCRIPTION

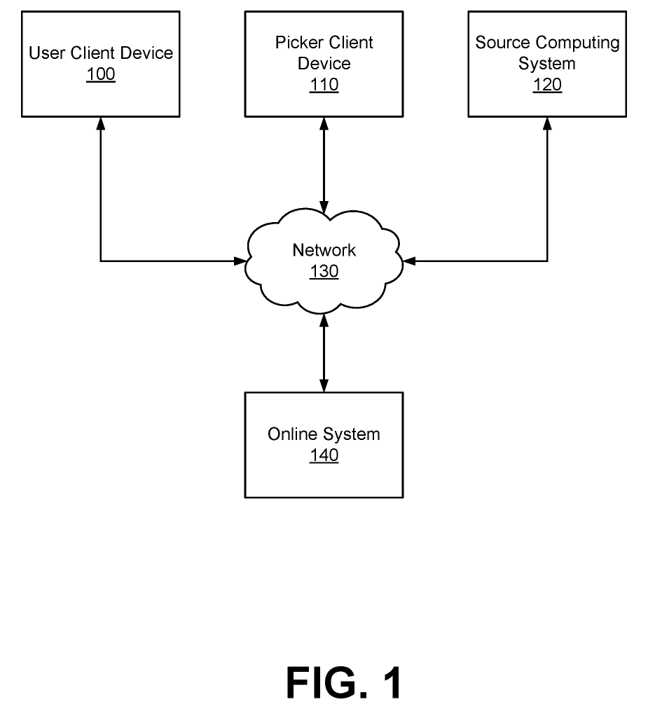

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

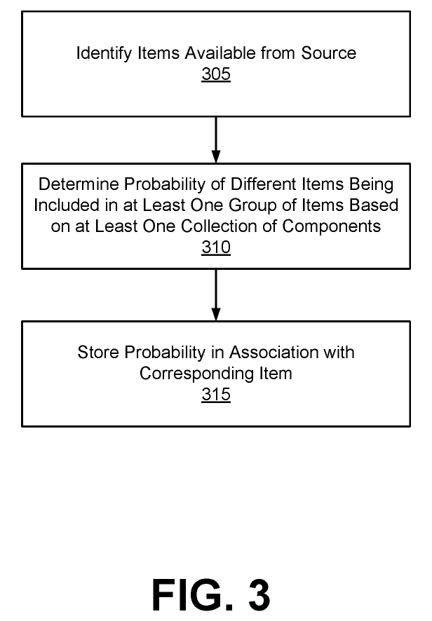

In various embodiments, the ordering interface receives a collection of components from a user rather than selections of individual items from a user for an order. A component comprises an attribute or description applicable to one or more specific items available from a source. For example, a component is a generic item description associated with multiple specific items available from a source. A generic item description may be an item category or other information identifying one or more attributes common to one or more specific items. In some embodiments, the user identifies a third party system and an identifier of a collection of components maintained by the third party system via the ordering interface, and the online system 140 subsequently retrieves the identified collection of components from the third party system. Identifying a collection of components simplifies generation of an order for a user by allowing the user to specify components, rather than specific items, and the online system 140 maps components to corresponding specific items, as further described below in conjunction with FIG. 3.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

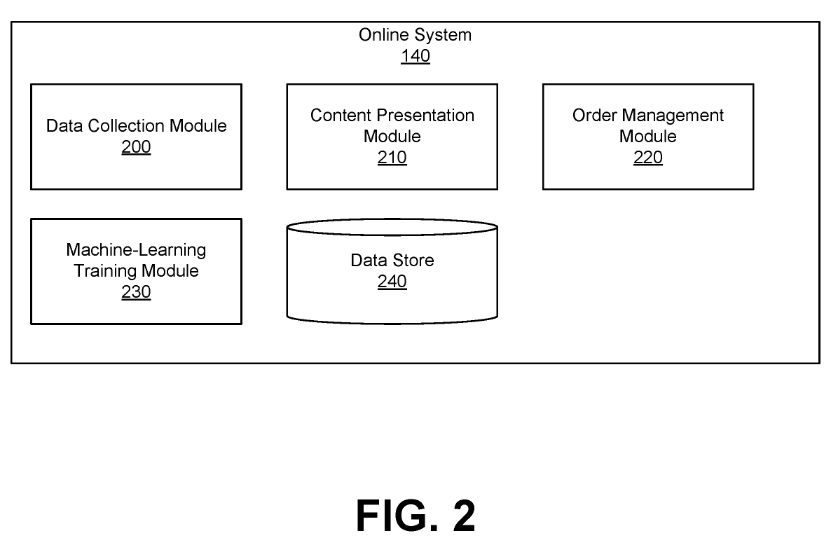

As an example, the online system 140 may allow a user to order groceries from a grocery store source. The user’s order may specify which groceries they want to be delivered from the grocery store and the quantities of each of the groceries. The user’s client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

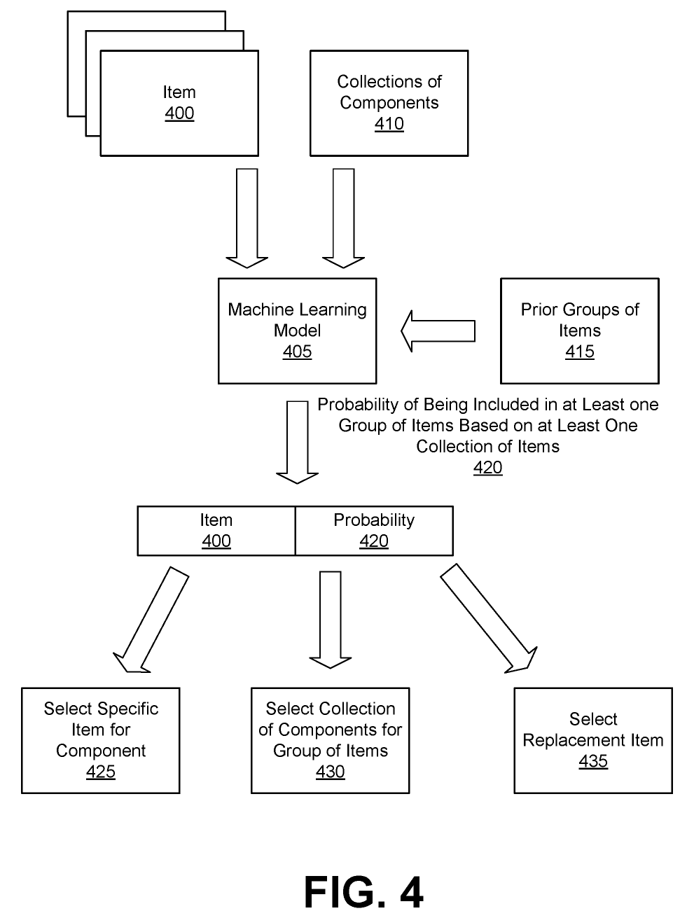

In various embodiments, the order management module 220 receives a collection of components from a user as an order. As one or more specific items available from a source included in the order may be associated with a component, the collection of components does not include sufficient detail for items to be obtained by a picker. To generate an order from a collection of components, the order management module 220 retrieves items available from a source included in an order with the collection of components and maps each component of the collection to a specific item available from the source. In various embodiments, the order management module 220 leverages probabilities of items available from a source being included in at least one order based on at least one collection of components when selecting a specific item for a component of a collection. As further described below in conjunction with FIGS. 3 and 4, the order management module 220 may determine a probability of each specific item available from a source being included in at least one order based on at least one collection of components using a machine-learning model and store the probabilities in association with corresponding specific items. In some embodiments, the online system 140 filters items available from a source based on their probabilities being included in at least one order based on at least one collection of components to reduce a number of items available from the source evaluated for mapping to a component, as further described below in conjunction with FIGS. 3 and 4.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In various embodiments, the machine-learning training module 230 trains a machine-learning model to generate a probability of an item being included in at least one group of items based on at least one collection of components. The machine-learning training module 230 applies the machine-learning model to multiple training examples of a training dataset. Each training example includes attributes of a training item and has a label indicating whether a training user included the training item in one or more groups of items (e.g., orders) based on one or more collections of components. For example, the label has a specific value in response to the training user including the training item in a group of items based on a collection of components and has an alternative value in response to the training user not including the training item in at least one group of items based on at least one collection of components. When applied to a training example, the machine-learning model generates a predicted probability of the training item being included in at least one group of items based on at least one collection of components using the attributes of the training item. The machine-learning training module 230 determines a score for the machine-learning model based on a difference between a label applied to a training example and a predicted probability for the training example (e.g., through application of a loss function to the label applied to t the training example and to the predicted probability of the training example). The machine-learning training module 230 updates the set of parameters for the interaction model based on the score generated by the loss function through backpropagation until one or more criteria are satisfied.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for determining probabilities of items available from a source being included in groups of items based on one or more collections of components, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 allows a user to select items from a source, which the online system 140 subsequently retrieves from the source and delivers to a location specified by the user. In various embodiments, the online system 140 receives a selection of a source and a group of items, such as an order including one or more items, from a user. The online system 140 allocates the group of items to a picker, who obtains the items from the source and delivers the obtained items to a location specified by the user.

To simplify user selection of a group of items, such as creation of an order, the online system 140 may receive a collection of components from a user, from a third party system, or from an application. Each component of a collection comprises one or more attributes or descriptive information applicable to one or more specific items available from a source. For example, a component is a generic item description associated with one or more specific items available from a source, while in other embodiments a component identifies one or more attributes of one or more specific items available from a source. As an example, a collection of components comprises a recipe, with each component corresponding to an ingredient of the recipe and having an associated quantity. In various embodiments, a third party system maintains various collections of components, and a user selects a collection from the third party system. In response to receiving the selection of the collection, the third party system transmits the selected collection to the online system 140 in conjunction with an identifier of the user. Selecting a collection allows a user to specify one or more components rather than to specify individual specific items for a group of items, reducing the amount of interaction by the user with the online system 140 to create a group of items.

While a collection of items includes multiple components, multiple specific items available from a source may be used as a component (i.e., “satisfy” the component). For example, a component of “milk” is satisfied by multiple specific items each comprising different brands of milk, different types of milk, or milk items having one or more differing attributes. Because multiple specific items available from a source may be used for a component, the online system 140 maps a component to a specific item available from a source to create a group of items capable of being obtained from the source. This mapping of components to specific items capable of being obtained from the source simplifies user creation of a group of items by leveraging one or more collections of components.

To map a component of a collection to a specific item, the online system 140 may generate a search query comprising a name or a description of the component and select a specific item based on measures of relevance of attributes of various specific items available from a source to the search query. A measure of relevance of a specific item to component is based on attributes of the specific item in various embodiments. The online system 140 selects a specific item having a maximum measure of relevance for the component in various embodiments. However, certain items available from a source may have high measures of relevance to a component in a collection but be nonsensical for use in the collection. Such a nonsensical specific item is a specific item that is inconsistent for use with other components in the collection. For example, a collection includes components corresponding to food items, while a specific item available from a source is a non-food item having attributes (e.g., a name, a description) causing a high measure of relevance to a component. In the preceding example, including the specific non-food item in the collection of food components would be nonsensical, as the specific non-food item would be incompatible with specific food items selected for other components of the collection. Presenting specific items for a component that are nonsensical to a user from whom a collection was received decreases a likelihood of the user subsequently providing other collections of components to the online system 140, as modifying a nonsensical item selected by the online system 140 to another specific item increases an amount of time and interaction with the online system 140 to create a group of items. Additionally, when selecting a specific item for a component of a collection, evaluating items available from the source that are ultimately nonsensical for the component increases a number of items evaluated for the component, increasing computational resources expended by the online system 140 when selecting a specific item for the component by increasing an amount of data evaluated by the online system 140.

To reduce computational resources for selecting specific items for corresponding components in a collection, while improving an accuracy of specific items selected for corresponding components, the online system 140 identifies 305 items available from a source and attributes of the identified items. For example, the online system 140 identifies a source and retrieves an item catalog associated with the source from the data store 240, or from a source computing system 120. An item catalog includes entries for each item available from the source, with an entry of the item catalog including an item identifier for an item and attributes of the item. Example attributes of an item include: a name of the item, a description of the item, a size of the item, or other descriptive information about the item. The online system 140 identifies 305 a set of items available from the source in some embodiments, with the set being less than the full item catalog of the source. For example, the online system 140 identifies a set of items having a specific item category from the item catalog.

For each identified item, the online system 140 determines 310 a probability of an item being included in at least one group of items based on at least one collection of components by one or more users. A higher probability for an item indicates the item is more likely to be included in at least one group of items based on a collection of components, while a lower probability for the item indicates the item is less likely to be included in at least one group of items based on a collection of components. In various embodiments, the online system 140 applies a trained machine-learning model to attributes of an item to determine 310 the probability of the item being included in at least one group of items corresponding to at least one collection of components.

In various embodiments, the online system 140 trains the machine-learning model based on prior inclusion of specific items in groups based on collections of components by users of the online system 140. For example, the online system 140 identifies previously fulfilled orders for users that were created based on collections of components and identifies specific items included in the previously fulfilled orders. In some embodiments, the online system 140 identifies previously fulfilled orders received from users having one or more common characteristics, such as users having a common geographic location. The online system 140 may train different machine-learning models for different common characteristics of users, such as training a different machine-learning model for different geographic locations.

The machine-learning model comprises a set of weights stored on a non-transitory computer readable storage medium. The online system 140 trains the machine-learning model by generating a training dataset including multiple training examples based on prior interactions with the online system 140 by training users. In various embodiments, each training example is based on a group of items, such as an order, created by a training user. Different training users may be associated with different training examples. Each training example includes attributes of a training item and has a label indicating whether the training user included the training item in at least one group of items based on at least one collection of components. For example, a label has a particular value in response to the training user including the training item in at least one group of items (e.g., an order) based on at least one collection of components and has an alternative value in response to the training user not including the training item in at least one group based on at least one collection of components.

To train the machine-learning model, the online system 140 initializes the set of weights comprising the machine-learning model and applies the machine-learning model to multiple training examples of the training dataset. Applying the machine-learning model to multiple training examples updates one or more parameters (e.g., the weights) comprising the machine-learning model. The parameters comprising the machine-learning model transform the input data – attributes of an item – into a predicted probability of one or more users including the item in at least one group of items based on at least one collection of components. When applied to a training example, the machine-learning model generates the predicted probability of a training item being included in at least one group of items based on at least one collection of components based on the attributes of the training item.

For each training example to which the machine-learning model is applied, the online system 140 generates a score comprising an error term based on the predicted probability of the training item being included in at least one group of items based on at least one collection of components and a label applied to the training example. The error term is larger when a difference between the predicted probability for the training example and the label applied to the training example is larger and is smaller when the difference between the predicted probability for the training example and the label applied to the training example is smaller. In various embodiments, the online system 140 generates the error term using a loss function based on a difference between the predicted probability for the training example and the label applied to the training example using a loss function. Example loss functions include a mean square error function, a mean absolute error, a hinge loss function, and a cross-entropy loss function.

The online system 140 backpropagates the error term to update the set of parameters comprising the machine-learning model and stops backpropagation in response to the error term, or to the loss function, satisfying one or more criteria. For example, the online system 140 backpropagates the error term through the machine-learning model to update parameters of the machine-learning model until the error term has less than a threshold value. For example, the online system 140 may apply gradient descent to update the set of parameters. The online system 140 stores the set of parameters comprising the machine-learning model on a non-transitory computer readable storage medium after stopping the backpropagation.

The online system 140 stores 315 the probability of the item being included in at least one group of items based on at least one collection of components by one or more users in association with the item. For example, the online system 140 stores 315 the probability of an item being included in at least one group of items based on at least one collection of components as an attribute of the item in the item catalog for the source. As an example, the online system 140 stores 315 the probability of the item being included in at least one group of items based on at least one collection of components in an entry of an item catalog for the item. Determining the probability of being included in at least one group of items based on at least one collection of components for different items available from the source allows the online system 140 to augment attributes of various items with information indicating how likely different items are to be included in groups of items based on collections of components.

Subsequently, the online system 140 leverages the stored probabilities of items being included in at least one group of items based on at least one collection of components in response to receiving a request from a user to create a group of items. For example, in response to receiving a request to create a group of items (e.g., an order) from a user that identifies the source and that includes a specific collection of components, the online system 140 identifies a component of the specific collection and retrieves a set of candidate items for the component of the specific collection of components based on the stored probabilities of items available from the source being included in at least one group of items based on at least one collection of components. In various embodiments, the online system 140 retrieves items having at least a threshold probability of being included in at least one group of items based on at least one collection of components as the set of candidate items. This reduces a number of items evaluated for the identified component of the specific collection of components by filtering the items available from the source based on their corresponding probabilities of being included in at least one group of items based on at least one collection of components. Additionally, retrieving items having at least the threshold probability of being included in at least one group of items based on at least one collection of components as the set of candidate items removes items available from the source that are unlikely to be included in at least one group of items based on at least one collection of components from evaluation, decreasing a likelihood of the online system 140 selecting an item available from the source for the component that would be nonsensical to include in the collection of components.

From the set of candidate items each having at least the threshold probability of being included in at least one group of items based on at least one collection of components, the online system 140 selects a specific item for the component of the specific collection. In various embodiments, the online system 140 applies a trained selection model to each of the set of candidate items and selects a candidate item based on scores generated by the selection model. For example, the selection model receives as input a candidate item, the component, and the specific collection of components. Based on the received input, the selection model generates a score for the candidate item indicating a probability of the candidate item being associated with the component of the specific collection. In some embodiments, the online system 140 selects a candidate item having a maximum score as the specific item for the component for the specific collection. Hence, the online system 140 filters the items available from the source to the set of candidate items based on their probabilities of being included in at least one group of items based on at least one collection, reducing a number of items evaluated for a component of the specific collection.

Alternatively, the online system 140 uses the probability of a specific item being included in at least one group of items based on at least one collection of components as an input to the selection model, rather than filtering specific items available from the source based on their probabilities of being included in at least one group of items based on at least one collection of components. For example, the online system 140 receives a request to create a group of items identifying the source and including a specific collection of components and identifies a component of the specific collection. For each of at least a set of items available from the source, the online system 140 applies the selection model to: characteristics of the user, the specific collection of components, and attributes of an item available from the source. An attribute of an item available from the source comprises the probability of the item being included in at least one group based on at least one collection of components. The selection model generates a score for each item, and the online system 140 selects a specific item available from the source for the component of the specific collection based on the scores. For example, the online system 140 selects a specific item available from the source having a maximum score for the component of the specific collection. As another example, the online system 140 ranks specific items available from the source based on their scores and selects one or more specific items having at least a threshold position in the ranking for the component of the specific collection.

In other embodiments, the online system 140 receives a group of specific items available from the source from a user. For example, the online system 140 receives an order from a user that includes one or more specific items and that identifies the source. To increase a number of items that the user includes in the group, the online system 140 retrieves probabilities of each specific item of the group being included in at least one group of items based on at least one collection of components. The online system 140 selects a set of specific items from the group that each have at least a threshold probability of being included in at least one group based on at least one collection of components. Based on the set of specific items, the online system 140 selects one or more collections of components including components corresponding to at least a threshold amount of the specific items of the group. For example, the online system 140 selects one or more collections of components having at least a threshold number of components associated with the set of items. In another example, the online system 140 selects one or more collections of components having at least a threshold percentage of components associated with the set of items. Subsequently, the online system 140 transmits a description of the selected one or more collections of components to a user client device 100 of the user. Identifying the description of the selected collection of components to the user identifies additional components to prompt the user to select additional specific items corresponding to the additional components for the group of items to increase a number of specific items in the group for the online system 140 to obtain. The online system 140 may identify a single selected collection of components to the user in some embodiments or may show multiple selected collections of components to the user in other embodiments.

Further, the online system 140 uses stored probabilities of each specific item of the group being included in at least one group of items based on at least one collection of components when selecting one or more replacement items for an item included in a group of items. For example, a picker obtaining items from the source for a user transmits an indication to the online system 140 that a specific item included in a group of items (e.g., an order) is unavailable at the source. In response to receiving the indication, the online system 140 presents one or more replacement items for the unavailable item to the user. Alternatively, the online system 140 presents one or more replacement items for an item having less than a threshold predicted availability at the source when the online system 140 receives a group of items including the item. Presenting one or more replacement items simplifies selection of a replacement item by the user for an item unavailable at the source.

To simplify selection of a replacement item by the user, the online system 140 selects one or more candidate replacement items for an item (e.g., an item unavailable at the source, an item having less than a threshold predicted availability) for presentation to the user. The online system 140 selects a set of candidate replacement items having at least a threshold probability of being included in at least one group based on at least one collection of components and selects one or more candidate replacement items for presentation to the user from the set of candidate replacement items. This filtering of items available from the source based on probabilities of being included in at least one group based on at least one collection of components reduces a number of items available from the source that are evaluated for replacing an item. In various embodiments, the online system 140 applies a replacement model to each candidate replacement item of the set, which generates a replacement score for each candidate replacement item. Based on the replacement scores, the online system 140 selects one or more candidate replacement items for presentation to the user. For example, the online system 140 ranks the candidate replacement items based on their replacement scores and selects one or more candidate replacement items having at least a threshold position in the ranking. As another example, the online system 140 selects candidate replacement items having at least a threshold replacement score.

Alternatively, the online system 140 uses the probability of a specific item being included in at least one group of items based on at least one collection of components as an input to the replacement model, rather than filtering items available from the source based on probabilities of being included in at least one group of items based on at least one collection of components. For example, the online system 140 receives an indication a specific item is unavailable at the source, such as from a picker obtaining items from the source or determines that the item has less than a threshold predicted availability at the source, and applies the replacement model to each of a set of specific items available from the source. For example, the set of specific items comprises specific items available from the source having a common item category with the unavailable item. The replacement model receives characteristics of the user, attributes of a specific item unavailable from the source, and attributes of a specific item available from the source, with an attribute of the specific item available from the source comprising the probability of the specific item available from the source being included in at least one group based on at least one collection of components by one or more users as input. The replacement model generates a replacement score for each of a set of specific items available from the source, and the online system 140 selects one or more candidate replacement items based on the replacement scores. For example, the online system 140 selects one or more candidate replacement items as specific items having at least a threshold replacement score. As another example, the online system 140 ranks specific items available from the source based on their replacement scores and selects one or more specific items having at least a threshold position in the ranking as candidate replacement items.

In various embodiments, the online system 140 compares the probability of the item being included in at least one group of items based on at least one collection of components to a threshold value. In response to the probability of the item being included in at least one group of items based on at least one collection of components being less than a threshold value, the online system 140 evaluates the item for presentation to the user for a component. The online system 140 generates an additional training example based on an interaction by a user with a group of items that includes the item for a component of a collection. For example, the additional training example includes the item and a label indicating whether the user included the item in the group or removed the item from the group. Subsequently, the online system 140 applies the machine-learning model to the additional training example, generates a score for the additional training example based on a difference between the label of the additional training example and a predicted probability of the item being included in at least one group of items based on at least one collection of components, and modifies one or more parameters based on the score, as further described above. The threshold value allows the online system 140 to present the item to one or more users to obtain additional training examples for refining the machine-learning model.

In some embodiments, the online system 140 compares the probability of the item being included in at least one group of items based on at least one collection of components to a minimum value and to a maximum value. In response to the probability exceeding the maximum value, the online system 140 evaluates the item for mapping to a component. Conversely, in response to the probability being less than the maximum value, the online system 140 withholds the item from evaluation for mapping to a component. However, in response to the probability being greater than the minimum value and less than the maximum value, the online system 140 presents the item to one or more administrative users for manual review. An administrative user generates an additional training example including the item and a label applied by the administrative user. The label indicates whether the item would be included in at least one group of items based on at least one collection of components. Subsequently, the online system 140 applies the machine-learning model to the additional training example, generates a score for the additional training example based on a difference between the label of the additional training example and a predicted probability of the item being included in at least one group of items based on at least one collection of components, and modifies one or more parameters based on the score, as further described above.

Hence, determining 310 probabilities of various items available from a source being included in at least one group of items based on at least one collection of components simplifies subsequent selection of one or more specific items by the online system 140. The online system 140 may filter specific items available from the source by their probabilities of being included in at least one group of items based on at least one collection of components to reduce a number of items available from the source that are evaluated by the online system 140. Such filtering reduces computational resources used by the online system 140 selecting certain items and reduces an amount of time spent by the online system 140 selecting specific items. Additionally, storing probabilities of various items available from a source being included in at least one group of items based on at least one collection of components improves an accuracy of specific items selected by the online system 140 for one or more components, reducing an amount of interaction by users with the online system 140 to generate a group of items, such as an order, based on a collection of components by reducing a likelihood of users modifying a generated group of items to modify or to remove one or more nonsensical items selected by the online system 140.

FIG. 4 is a process flow diagram of a method for determining probabilities of items available from a source being included in groups of items based on one or more collections of components, in accordance with some embodiments. The online system 140 allows a user to select items from a source, which the online system 140 subsequently retrieves from the source and delivers to a location specified by the user. In various embodiments, the online system 140 receives a selection of a source and a group of items, such as an order including one or more items, from a user. The online system 140 allocates the group of items to a picker, who obtains the items from the source and delivers the obtained items to a location specified by the user.

To simplify selection of a group of items by a user, such as creation of an order, the online system 140 may receive a collection of components from a user, from a third party system, or from an application. Each component of a collection comprises one or more attributes or descriptive information applicable to one or more specific items available from a source. In some embodiments, a component is a generic item description associated with one or more specific items available from a source, while in other embodiments a component identifies one or more attributes of one or more specific items available from a source.

However, multiple specific items available from a source may satisfy a component. For example, a component of “bread” is satisfied by multiple specific items available from a source that each comprise different brands of bread, different types of bread, or milk items having one or more differing attributes. Because multiple specific items available from a source may be used for a component, to create a group of specific items capable of being obtained from the source, the online system 140 maps a component to a specific item available from a source. Mapping each component of a collection to a corresponding specific item available from a source allows creation of a group of items capable of being obtained from a source for the collection of components.

To map a component to a specific item, the online system 140 may generate a search query based on one or more attributes of the component (e.g., a name of the component, a description of the component) and select a specific item based on measures of relevance of attributes of various items available from a source to the search query. However, certain items available from a source may have high measures of relevance to a component in a collection but be nonsensical for use in the collection. A specific item is nonsensical for a collection if the specific item is inconsistent or incompatible with other components (or with specific items mapped to other components) of the collection. For example, a collection includes components corresponding to food items, while a specific item available from a source is a non-food item having attributes (e.g., a name, a description) causing a high measure of relevance to one of the components. In the preceding example, including such a specific non-food item in the collection of food components would be nonsensical, as the specific non-food item is incompatible with specific food items for the other components of the collection. When selecting a specific item for a component of a collection, evaluating items available from the source that would be nonsensical for the component also increases a number of items evaluated for the component, increasing computational resources expended by the online system 140 for selecting a specific item for the component.

To reduce computational resources used for mapping a component to a specific item and to increase an accuracy of mapping of specific items to components, the online system 140 identifies items available from a source. For example, the online system 140 retrieves an item catalog for a source, with the item catalog identifying each item available from the source. The online system 140 identifies an item 400 available from the source and applies a machine-learning model 405 to the item 400. The machine-learning model 405 is trained based on collections 410 of components and prior groups 415 of items previously created by users of the online system 140. As further described above in conjunction with FIG. 3, the online system 140 generates training examples for the machine-learning model 405 that each include attributes of a training item, with each training example having a label applied indicating whether the training item was included in at least one prior group 415 of items based on at least one collection 410 of components by one or more users. For example, a training example includes attributes of a training item and a label indicating whether a prior group 415 of items based on at least one collection 410 of components included the training item. Through a backpropagation process further described above in conjunction with FIG. 3, the online system 140 modifies one or more parameters of the machine-learning model 405 during a training process.

Applying the machine learning model 405 to attributes of the item 400 generates a probability 420 of the item 400 being included in at least one group of items based on at least one collection 410 of components by one or more users. The probability 420 provides an indication whether the item 400 is suitable for inclusion in a group of items based on a collection 410 of components based on prior inclusion of items in one or more prior groups 415 corresponding to one or more collections 410 of components. The online system 140 stores the probability 420 in association with the item 400. In various embodiments, the probability 420 is an attribute of the item 400 stored in association with an identifier of the item 400. For example, the probability is included in an entry of the item catalog for the source associated with the item 400 for subsequent retrieval by the online system 140.

Storing the probability 420 in association with the item 400 allows subsequent leverage of the probability 420 of the item 400 being included in one or more groups of items based on one or more collections of components when selecting items, or other content, for a user. In various embodiments, the online system 140 receives a request to create a group of items including a specific collection of components. For a component of the specific collection, the online system 140 selects a set of candidate items that each have at least a threshold probability of being included in one or more groups of items based on one or more collections of components. Hence, the online system 140 selects 425 an item having at least a threshold probability of being included in one or more groups of items based on one or more collections of components for the component of the specific collection. Filtering items available by the source based on their probabilities of being included in one or more groups of items based on one or more collections of components when selecting 425 an item for a component reduces a number of items available from the source evaluated by the online system 140. Alternatively, as further described above in conjunction with FIG. 3, the online system 140 includes the probability 420 of the item 400 being included in one or more groups of items based on one or more collections of components as an attribute of the item 400 provided as input to a selection model generating a score used by the online system 140 to determine whether to select the item 400 to a component.

Alternatively or additionally, the online system 140 receives a group of items (e.g., an order) from a user and selects 430 a collection of components based on the group of items. For example, the collection of components selected 430 by the online system 140 includes at least a threshold amount of the items in the received group. To select 430 the collection of components, the online system 140 identifies a set of items of the group that each have a stored probability 420 of being included in one or more groups of items based on one or more collections of components. This removes items of the received group having less than the threshold probability 420 of being included in one or more groups of items based on one or more collections of components from subsequent evaluation by the online system 140, reducing an amount of data processed by the online system 140. Based on the set of items, the online system 140 selects 430 one or more collections that each include at least a threshold amount of items of the set of items and identifies the selected one or more collections to the user. Selecting one or more collections based on specific items of the group having at least the threshold probability 420 of being included in one or more groups of items based on one or more collections of components both reduces a number of specific items that the online system 140 evaluates and increases an accuracy of the one or more collections selected 430 by the online system 140 for the received group of items by basing selection of one or more collections on specific items that are likely to be included in one or more groups based on at least one collection of components.

Additionally, when a specific item in a group received from a user is unavailable at a source, the online system 140 may identify one or more candidate replacement items that are available at the source for the unavailable item. Identifying the one or more candidate replacement items allows the user to more easily select an alternative item for the group that is similar to the unavailable item. An item may be unavailable at the source in response to a picker obtaining a group of items transmitting an indication to the online system 140 that the item is unavailable or in response to the online system 140 determining a predicted availability of the item at the source is less than a threshold. In various embodiments, to select 435 candidate replacement items, the online system 140 selects a set of candidate replacement items available from the source that each have at least a threshold probability of being included in at least one group based on at least one collection of components and selects one or more of the candidate replacement items for presentation to the user. Filtering items available from the source so the set of candidate replacement items each have at least the threshold probability of being included in at least one group based on at least one collection of components reduces a number of items available from the source evaluated for presentation to the user as a candidate replacement item. Alternatively or additionally, the online system 140 uses the probability 420 of being included in at least one group of items based on at least one collection of components for the item 400 as an input to a replacement model that generates a replacement score for the item 400 replacing the unavailable item, rather than filtering items available from the source based on their probabilities of being included in at least one group of items based on at least one collection of components. For example, the online system 140 applies the replacement model to: characteristics of the user, attributes of the item unavailable from the source, and attributes of the item 400 available from the source including the probability 420 of the item 400 being included in at least one group based on at least one collection of components. Based on the replacement scores for items available from the source, the online system 140 selects one or more candidate replacement items for presentation to the user, as further described above in conjunction with FIG. 3.

Determining probabilities of various items available from a source being included in at least one group of items based on at least one collection of components simplifies subsequent selection of one or more specific items available from the source by the online system 140. For example, the online system 140 filters items available from the source by their probabilities of being included in at least one group of items based on at least one collection of components to reduce a number of items available from the source evaluated by the online system 140. This filtering reduces computational resources used by the online system 140 by reducing a number of items the online system 140 evaluates, which also reduces an amount of time spent by the online system 140 selecting items for a component of a collection. Storing probabilities of various items available from a source being included in at least one group of items based on at least one collection of components also improves an accuracy with which the online system 140 selects specific items selected by the online system 140 for one or more components (or improves an accuracy of a collection of components selected based on a group of specific items), reducing an amount of interaction by users with the online system 140 to generate a group of items, such as an order, based on a collection of components by reducing a likelihood of the users having to modify one or more items the online system 140 selected for one or more components.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
identifying a plurality of items stored in a database, wherein the database further stores a set of attributes for each item;
for each of the plurality of items, generating a probability that the item matches an ingredient from a reference set of recipes, by applying a machine-learning model to the attributes of the item, wherein the machine-learning model is trained by:
obtaining a plurality of training examples, each training example including a training item and each training example having a label indicating whether the training item matches an ingredient from a reference set of recipes;
applying the machine-learning model to each training example to generate a predicted probability that the training item matches an ingredient from a reference set of recipes;
scoring the machine-learning model using a loss function, wherein the loss function is based on a difference between the predicted probability and the label of the training example; and
updating one or more parameters of the machine-learning model by backpropagation based on the scoring;
storing the generated probabilities for each of the plurality of items in the database;
receiving a request to create an order comprising a set of items from the database that match a set of ingredients for a target recipe;
retrieving, from the database, a plurality of candidate items for a particular ingredient of the target recipe;
for one or more of the candidate items, retrieving the probability that the candidate item matches an ingredient from a reference set of recipes; and
filtering at least one of the candidate items based on the retrieved probability that the candidate item matches an ingredient from a reference set of recipes.

2. The method of claim 1, wherein obtaining a particular training example of plurality of training examples comprises:
for a particular training item associated with the training example, identifying a particular ingredient from the reference set of recipes wherein the particular ingredient defines a category of items to which the particular training item belongs; and
responsive to the identifying, labeling the particular training example to indicate that the training item matches an ingredient from a reference set of recipes.

3. The method of claim 1, further comprising:
creating the order, wherein creating the order comprises adding to the order one of the candidate items that was not filtered.

4. The method of claim 1, further comprising:
receiving a target recipe;
identifying an ingredient from the recipe;
applying a selection model to a set of input features to score a match of a candidate item to the identified ingredient, wherein the set of input features comprises the stored probability for the candidate item; and
recommending adding the candidate item to an order for the identified ingredient based on the score from the selection model.

5. The method of claim 1, further comprising:
receiving an order, the order comprising a set of the items stored in the database;
selecting a subset of the set of items in the order, wherein each of the selected subset of items has at least a threshold probability that the item matches an ingredient from a reference set of recipes;
matching a target recipe, from a plurality of candidate recipes, to the selected subset of items; and
transmitting a description of the selected target recipe from the computer system to a user client device of the user.

6. The method of claim 1, further comprising:
receiving, at the computer system, an indication that a specific item included in an order is unavailable at a source;
retrieving a set of candidate replacement items for the specific item;
applying a replacements model to a set of input features to score each of the candidate replacement items for the specific item, wherein the set of input features for scoring each candidate item comprises the stored probability for the candidate item;
selecting one of the candidate replacement items for the specific item from the set of candidate replacement items based on the scores; and
transmitting the selected candidate replacement item to a picker associated with the order.

7. The method of claim 1, further comprising:
retrieving a set of candidate replacement items for a specific item in an order, each candidate replacement item having at least a threshold probability that the candidate replacement item matches an ingredient from a reference set of recipes; and
selecting, by the computing system, one or more of the candidate replacement items for the specific item from the set of candidate replacement items.

8. The method of claim 1, further comprising:
receiving, by the computing system, a request to create an order based on a target recipe, the target recipe including a plurality of ingredients;
in response to the probability that a candidate item matches an ingredient from a reference set of recipes being less than a threshold value, including the candidate item in a set of candidate items for an ingredient of the target recipe; and
adding one of the candidate items for the ingredient to the order.

9. The method of claim 8, further comprising:
generating an additional training example including the added candidate item and a label indicating whether the order was completed with the added candidate item; and
re-training the machine-learning model using the additional training example.

10. A computer program product comprising a non-transitory computer readable storage medium having instructions encoded thereon that, when executed by a processor of a computing system, cause the processor to perform steps comprising:
identifying a plurality of items stored in a database, wherein the database further stores a set of attributes for each item;
for each of the plurality of items, generating a probability that the item matches an ingredient from a reference set of recipes, by applying a machine-learning model to the attributes of the item, wherein the machine-learning model is trained by:
obtaining a plurality of training examples, each training example including a training item and each training example having a label indicating whether the training item matches an ingredient from a reference set of recipes;
applying the machine-learning model to each training example to generate a predicted probability that the training item matches an ingredient from a reference set of recipes;
scoring the machine-learning model using a loss function, wherein the loss function is based on a difference between the predicted probability and the label of the training example; and
updating one or more parameters of the machine-learning model by backpropagation based on the scoring;
storing the generated probabilities for each of the plurality of items in the database;
receiving a request to create an order comprising a set of items from the database that match a set of ingredients for a target recipe;
retrieving, from the database, a plurality of candidate items for a particular ingredient of the target recipe;
for one or more of the candidate items, retrieving the probability that the candidate item matches an ingredient from a reference set of recipes; and
filtering at least one of the candidate items based on the retrieved probability that the candidate item matches an ingredient from a reference set of recipes.

11. The computer program product of claim 10, wherein obtaining a particular training example of plurality of training examples comprises:
for a particular training item associated with the training example, identifying a particular ingredient from the reference set of recipes wherein the particular ingredient defines a category of items to which the particular training item belongs; and
responsive to the identifying, labeling the particular training example to indicate that the training item matches an ingredient from a reference set of recipes.

12. The computer program product of claim 10, wherein the non-transitory computer readable storage medium further has instructions encoded thereon that, when executed by the processor, cause the processor to perform steps comprising:
receiving a request to create an order comprising a set of items from the database that match a set of ingredients for a target recipe;
retrieving, from the database, a plurality of candidate items for a particular ingredient of the target recipe;
for one or more of the candidate items, retrieving the probability that the candidate item matches an ingredient from a reference set of recipes;
filtering at least one of the candidate items based on the retrieved probability that the candidate item matches an ingredient from a reference set of recipes; and
creating the order, wherein creating the order comprises adding to the order one of the candidate items that was not filtered.

13. The computer program product of claim 10, wherein the non-transitory computer readable storage medium further has instructions encoded thereon that, when executed by the processor, cause the processor to perform steps comprising:
receiving a target recipe;
identifying an ingredient from the recipe;
applying a selection model to a set of input features to score a match of a candidate item to the identified ingredient, wherein the set of input features comprises the stored probability for the candidate item; and
recommending adding the candidate item to an order for the identified ingredient based on the score from the selection model.

14. The computer program product of claim 10, wherein the non-transitory computer readable storage medium further has instructions encoded thereon that, when executed by the processor, cause the processor to perform steps comprising:
receiving an order, the order comprising a set of the items stored in the database;
selecting a subset of the set of items in the order, wherein each of the selected subset of items has at least a threshold probability that the item matches an ingredient from a reference set of recipes;
matching a target recipe, from a plurality of candidate recipes, to the selected subset of items; and
transmitting a description of the selected target recipe from the computing system to a user client device of the user.

15. The computer program product of claim 10, wherein the non-transitory computer readable storage medium further has instructions encoded thereon that, when executed by the processor, cause the processor to perform steps comprising:
receiving, at the computing system, an indication that a specific item included in an order is unavailable at a source;
retrieving a set of candidate replacement items for the specific item;
applying a replacements model to a set of input features to score each of the candidate replacement items for the specific item, wherein the set of input features for scoring each candidate item comprises the stored probability for the candidate item;
selecting one of the candidate replacement items for the specific item from the set of candidate replacement items based on the scores; and
transmitting the selected candidate replacement item to a picker associated with the order.

16. The computer program product of claim 10, wherein the non-transitory computer readable storage medium further has instructions encoded thereon that, when executed by the processor, cause the processor to perform steps comprising:
retrieving a set of candidate replacement items for a specific item in an order, each candidate replacement item having at least a threshold probability that the candidate replacement item matches an ingredient from a reference set of recipes; and
selecting, by the computing system, one or more of the candidate replacement items for the specific item from the set of candidate replacement items.

17. The computer program product of claim 10, wherein the non-transitory computer readable storage medium further has instructions encoded thereon that, when executed by the processor, cause the processor to perform steps comprising:
receiving, by the computing system, a request to create an order based on a target recipe, the target recipe including a plurality of ingredients;
in response to the probability that a candidate item matches an ingredient from a reference set of recipes being less than a threshold value, including the candidate item in a set of candidate items for an ingredient of the target recipe; and
adding one of the candidate items for the ingredient to the order.

18. The computer program product of claim 17, wherein the non-transitory computer readable storage medium further has instructions encoded thereon that, when executed by the processor, cause the processor to perform steps comprising:
generating an additional training example including the added candidate item and a label indicating whether the order was completed with the added candidate item; and
re-training the machine-learning model using the additional training example.

19. A system comprising:
a processor; and
a non-transitory computer readable storage medium having instructions encoded thereon that, when executed by the processor, cause the processor to perform steps comprising:
identifying a plurality of items stored in a database, wherein the database further stores a set of attributes for each item;
for each of the plurality of items, generating a probability that the item matches an ingredient from a reference set of recipes, by applying a machine-learning model to the attributes of the item, wherein the machine-learning model is trained by:
obtaining a plurality of training examples, each training example including a training item and each training example having a label indicating whether the training item matches an ingredient from a reference set of recipes;
applying the machine-learning model to each training example to generate a predicted probability that the training item matches an ingredient from a reference set of recipes;
scoring the machine-learning model using a loss function, wherein the loss function is based on a difference between the predicted probability and the label of the training example; and
updating one or more parameters of the machine-learning model by backpropagation based on the scoring;
storing the generated probabilities for each of the plurality of items in the database;
receiving a request to create an order comprising a set of items from the database that match a set of ingredients for a target recipe;
retrieving, from the database, a plurality of candidate items for a particular ingredient of the target recipe;
for one or more of the candidate items, retrieving the probability that the candidate item matches an ingredient from a reference set of recipes; and
filtering at least one of the candidate items based on the retrieved probability that the candidate item matches an ingredient from a reference set of recipes.

20. The system of claim 19, wherein the non-transitory computer readable storage medium further has instructions encoded thereon that, when executed by the processor, cause the processor to perform steps comprising:
for a particular training item associated with the training example, identifying a particular ingredient from the reference set of recipes wherein the particular ingredient defines a category of items to which the particular training item belongs; and
responsive to the identifying, labeling the particular training example to indicate that the training item matches an ingredient from a reference set of recipes.
